(19) United States
(12) Patent Application Publication
(10) Pub. No.: US 2016/0231522 A1
(43) Pub. Date: Aug. 11, 2016

(54) COUPLING DEVICE OF OPTICAL WAVEGUIDE CHIP AND PD ARRAY LENS

(71) Applicant: Accelink Technologies Co., Ltd., Hubei (CN)

(72) Inventors: Chuan Shi, Wuhan (CN); Huali Xi, Wuhan (CN); Xuerui Liang, Wuhan (CN); Zheng Chen, Wuhan (CN); Xiong Jiang, Wuhan (CN); Weidong Ma, Wuhan (CN)

(73) Assignee: Accelink Technologies Co., Ltd., Wuhan (CN)

(21) Appl. No.: 15/024,086

(22) PCT Filed: Dec. 17, 2013
(86) PCT No.: PCT/CN2013/089661

§ 371 Date: Mar. 23, 2016

(30) Foreign Application Priority Data
Sep. 23, 2013 (CN) 201310433022.2

(51) Int. Cl. G02B 6/43; G02B 6/32; G02B 6/42

(52) U.S. Cl. CPC G02B 6/43; G02B 6/4214; G02B 6/325; G02B 6/4206; G02B 6/4269; G02B 6/4295

(57) ABSTRACT

A coupling device of an optical waveguide chip and a PD array lens. The coupling device comprises a waveguide chip, a PD array, a heat sink, a waveguide gasket and a substrate. The waveguide gasket and the heat sink are located on the substrate, the PD array is located on the heat sink, and the waveguide chip is provided on the waveguide gasket. A reflection prism is provided in an optical path between the waveguide chip and the PD array. The output light of the waveguide chip is reflected by the reflection prism, and then is received by the PD array. A lens array having a convergence effect is provided in the optical path between the waveguide chip and the PD array. The coupling device can reduce costs and has a simple structure, the assembly process thereof is easy to realize, and the photoelectric conversion efficiency thereof is high.

### TECHNICAL FIELD

Embodiment of invention involves a coupling device of optical module applied to optical communication technology, in particular, an optical coupling device with larger tolerance between optical transmission medium (optical fiber, optical waveguide) and the optical semiconductor element (semiconductor laser, photodiodes) in the optical module. Embodiment of the invention belongs to the field of optical communication.

### TECHNICAL BACKGROUND

With arising of smart devices, cloud computing and internet of things, requirement of network bandwidth demand continues to rise, and it is imminent to improve the system transmission rate. Transmission system with 100G and higher rate will be applied. Currently, 100G DWDM (Dense Wavelength Division Multiplexing, DWDM) optical transmission system using dual-polarization quadrature phase shift keying (DP-QPSK) technique, has prominent advantage mainly lying in technical revolution on realization, such as technologies of QPSK modulation, polarization multiplexing, coherent differential detection technology as so on, as compared to the previous transmission system.

100G DWDM optical transmission system mainly comprises of an optical transmitter, transmission line and optical receiver, wherein an integrated coherent receiver (ICR) causes the system to analyze polarization and phase relationships between the signal light and the additive reference light source to restore signal of 100G DP-QPSK phase and polarization constellation. 100G integrated coherent receiver is implemented in manner of 4×25G with single-channel electrical transmission rate of 25 Gb/s. Because bandwidth of light detector is related to crossing time of the carriers in the semiconductor material and response time of signal processing circuit, as compared to high-speed photodiode (PD), low-speed PD photodetector has a smaller crossing time, and smaller photosensitive surface with size in order of several tens of microns. It is more difficult for operation to use optical alignment of hybrid integration scheme between the optical waveguide chip and photodetector, while it is more sensitive to relative position deviation of outgoing light spot of the optical waveguide chip and PD photosensitive surface. Coupling efficiency of hybrid integrated alignment directly affects the insertion loss, CMRR, responsiveness and other indicators of the device. Common coupling structures in the prior art are as following: DNTT designed coupling structure using the two-lens plus reflex prism, see Ohyama T, Ogawa I, Tanobe H. All-in-one 100-Gbit/s DP-QPSK coherent receiver using novel PLC-based integration structure with low-loss and wide-tolerance multi-channel optical coupling, OECC, 2010, wherein beam output from the optical waveguide passes through a first lens for beam expanding and collimation, then is reflected through total reflection prism with light deflected by 90°, finally passes through second lens for convergence, and converged spot irradiates to PD surface. However, since the coupling structure uses double lens, which bring additional cost, the optical path of which is more complex, it is difficult for operation in actual assembly process, and production efficiency is lower; \textcircled{2} Chinese Patent 200610125025.X, high efficiency coupling assembly based on oblique plane cylindrical lens fiber and coupling structure as shown by its production method, which is difficult to be fixed, cylindrical lens of which can only carry out convergence and condensation in one dimension of beam, cannot utilize coupling of fiber group or a plurality of output optical waveguides with PD array, because spot converged by the cylindrical lens is of slim shape, and the spot will irradiate to adjacent PD to bring crosstalk.

### SUMMARY OF INVENTION

An object of embodiment of the present invention is to overcome the technical drawbacks in the prior art, and propose a photocoupling device with simple structure, easy assembly process, high photoelectric conversion efficiency.

According to an embodiment of the present invention, there is provided an optical waveguide chip and PD array lens coupling device comprising a waveguide chip, a PD array, a heat sink (107), a waveguide gasket, and a substrate, wherein the waveguide gasket and the heat sink are located on the substrate, the PD array is positioned on the heat sink, the waveguide chip is set on the waveguide gasket, a reflection prism is set in optical path between the waveguide chip and the PD array, light output from the waveguide chip is reflected by the reflection prism, and received by the PD array, further a lens array with convergent effect is set in optical path between the waveguide chip and the PD array. If relative large coupling loss is acceptable, or PD photosensitive surface is relative large, the lens array may be omitted in above coupling structure according to actual situation.

Lens holders are set on both sides of the PD array. The lens array is fixed on the lens holders. Center of transmission surface of the lens array is aligned with center of photosensitive surface of the PD array. Cover glass is bonded on top side of the waveguide chip. The reflection prism is pasted to outside of the cover glass. Slope of reflection prism is corresponding to output side of the waveguide chip.

The reflection prism is of reflection angle of 30 to 60° (preferably 40 to 50°), and coated with reflection increasing film on reflection plane thereof.

Said output side of waveguide chip is provided with cut-out region on underlying substrate thereof, in order to ensure the mechanical structural stability of chip. The length of the cut-out region should not be too long, and should be controlled to be within 5 mm, in this example, a length of 2˜4 mm. Thickness of the cut-out region should be controlled to be within ⅔ of the entire thickness of the chip, in this example, thickness of 0.3˜0.5 mm.

Height H1 of the lens holder equals to sum of height H2 of PD array and distance L from bottom surface of the lens array to convergence point after beam passing the lens array to be converged.

There is proposed a second design of coupling structure based on the above structure: Cover glass is bonded on top side of the waveguide chip. Transparent sheet is pasted to end surface of the output of the waveguide chip. The lens array is bonded on the transparent sheet. Centers of apertures of the waveguide chip and the lens array are corresponded each other. The reflection prism is fixed on reflection prism holder, which is bonded on side of PD array, which is corresponding to slope of the reflection prism.

The waveguide chip is provided with four output channels with spacing of 250 μm therebetween in turn. Correspondingly, lens array (104) is consisted of four lenses with spacing of 250 μm therebetween in turn. In this example, number of channels and channel spacing of waveguide chips are 4 and 250 μm. In actual use, the number of channels and channel spacing may be other values, which also fall within the scope of the invention.

Said output side of waveguide chip is provided with cut-out region on underlying substrate thereof, in order to ensure the mechanical structural stability of chip. The length of the cut-out region should not be too long, and should be controlled to be within 5 mm, in this example, a length of 2˜4 mm. Thickness of the cut-out region should be controlled to be within ⅔ of the entire thickness of the chip, in this example, thickness of 0.3˜0.5 mm.

End face of the output side of the waveguide chips is coated with antireflection film.

The transparent sheet is a glass or silicon sheet.

Embodiments of the present invention have following advantages:

1) In the device according to embodiment of the present invention, prism after cutting corner is pasted on cover glass of surface of the waveguide. The prism is easy to be fixed firmly, with compact structure, while optical distance of reflection optical path of the prism can be controlled by controlling pasted position of the prism, to prevent beam waist of spot irradiated to the lens array too large, thus forming optical signal crosstalk between adjacent PDs.

2) In the device according to embodiment of the present invention, the collimator lens array on output of the waveguide is omitted, using only a short focus focusing lens array, reducing the cost with simple structure and easier assembly process, and the photoelectric conversion efficiency is very high.

3) In the device according to embodiment of the present invention, the lens array is fixedly held above the PD array by two glass holder. The lens array and the PD array are optically aligned in passive manner by high-precision pasting. Its features of high precision and high efficiency are very suitable for industrial production.

4) In the device according to embodiment of the present invention, output waveguide of the waveguide chips is coated with antireflection film thereabove, with function for reducing return loss generated after light emitted from the waveguide chip.

5) In lens coupling solution with the device according to embodiment of the present invention, beam waist radius of converged beam by the lens array is small, which is suitable not only to coupling of waveguide chip or fiber array with low-speed PD array, but also to coupling of high-speed PD array, and can also be used for coupling of Vertical Cavity Surface Emitting Laser (VCSEL) to the waveguide chip or fiber.

### FIGURE DESCRIPTION

FIG. 1 is a structural diagram of a lens coupling device according to a first embodiment of the present invention;

FIG. 2 is a structural side-view of a lens coupling device according to a first embodiment of the present invention;

FIG. 3 is a structural diagram of a lens coupling device according to a second embodiment of the present invention;

FIG. 4 is a schematic diagram showing cutting of waveguide chip in the lens coupling device according to a first embodiment of the present invention;

among them:
101: waveguide chip
102: PD array;
103: lens array
104: reflection prism
105: cover glass
106: lens holder
107: heat sink
108: waveguide gasket
109: substrate
110: transparent sheet;
111: reflection prism holder
H1: height of the lens holder 106
H2: height of the PD array 102
L: distance from bottom surface of the lens array 103 to convergence point after beam passing the lens array 103 to be converged

### EMBODIMENTS

The implementation practice of embodiment of invention shall be explained in detail via specific embodiment and drawings below for a better understanding of this invention.

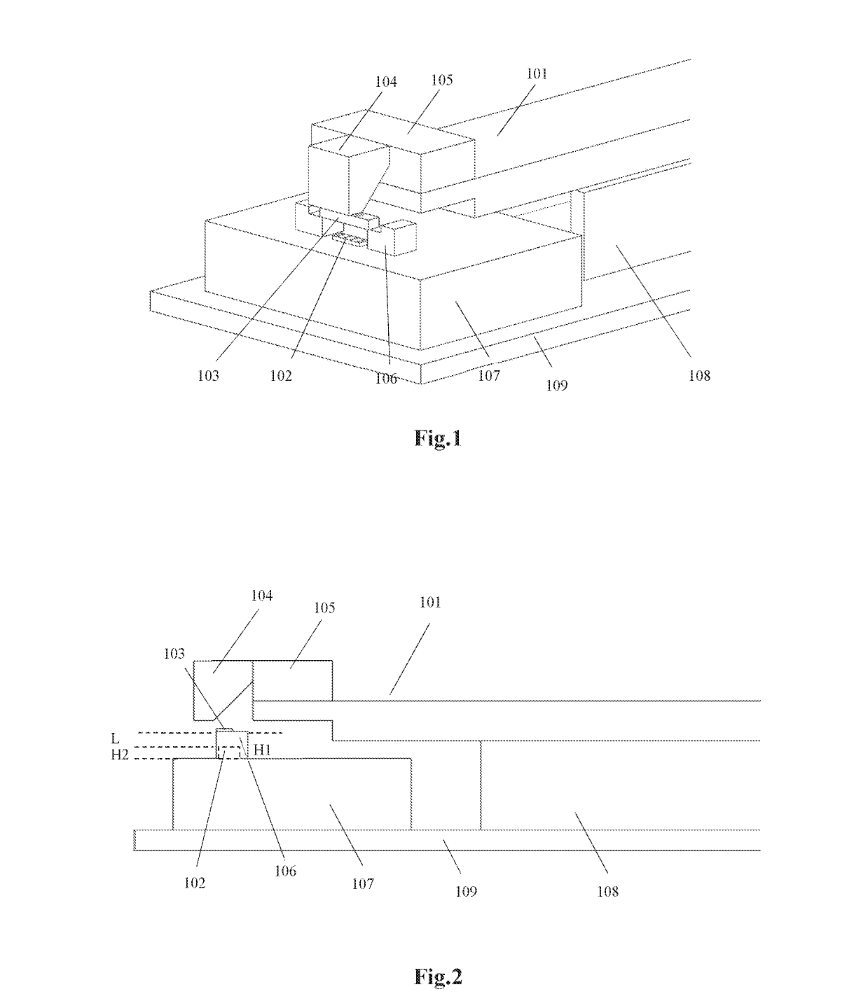

As shown in FIG. 1, a coupling device of an optical waveguide chip and a PD array lens includes a waveguide chip 101, a PD array 102, a lens array 103, a reflection prism 104, a cover glass 105, a lens holder 106, a heat sink 107, a waveguide gasket 108, a substrate 109. Heat sink 107 shown in FIG. 1 is located on the substrate 109. The PD array 102 is pasted on the heat sink 107 via conductive glue. The lens holder 106 is provided on the heat sink 107, and is a combination of two supports, which are located on each side of the PD array 102. The lens holder 106 is provided with elongated lens array 103, which is first fixed to the lens holder 106, which is formed of glass material. Through operation of pasting, the lens array 103 with the lens holder 106 is attached directly above the PD array 102. The lens holder 106 is bonded and fixed with the heat sink 107 by glue. In the operation of pasting, it is to ensure that the center of transmission surface of the lens array 103 is aligned with the center of photosensitive surface of the PD array 102 one by one, that is, a center of PD is aligned with a center of the lens. The waveguide gasket 108 is positioned beside the heat sink 107 on the substrate 109. The waveguide chip 101 is provided on the waveguide gasket 108 and has an output end face as vertical surface which is coated with antireflection film from silica to air. The cover glass 105 is bonded on the waveguide chip 101, and bonded with the reflection prism 104 thereoutside, which is parallel with upper surface of the cover glass 105, so that the slope of the reflection prism 104 corresponds to the output of the waveguide chip 101. Reflection angle of the reflection prism 104 is 30 to 60° (preferably 40 to 50°). Reflection plane is coated with reflection increasing film. Light emitted from the waveguide chip 101 is reflected by the slope of the reflection prism 104, then deflected by 60 to 120° (preferably 80 to 100°), and projected on the lens array 103. In the embodiment of the present invention, reverse angle of the reflection prism 104 is 45°. Lower substrate of the output of the waveguide chip 101 is provided with a cut-out region. in order to ensure the mechanical structural stability of chip. In view of mechanical reliability, the cut-out region should be of length less than 5 mm and thickness less than ⅔ of thickness of waveguide chip. In this example, the cut-out region is of a length of 2˜4 mm and thickness of 0.3˜0.5 mm. The embodiment is implemented as following: removing a part of the substrate of the output of the waveguide with length of 2˜4 mm and thickness of 0.3˜0.5 mm, which is due to the design of single lens solution for the coupling structure, which need control length of input optical path from input waveguide to the lens. Light emitted from the waveguide chip 101 is reflected by the slope of the reflection prism 104, then deflected, and projected on the lens array 103. Light converged by lens array 103 emits to photosensitive surface of the PD array 102 and is received by the PD array 102. The PD array 102 realizes signal transmission gold wire and electrical components connected thereto. As shown in FIG. 2, the lens holder 106 in embodiment of the present invention is of height H1 which is equal to height H2 of the PD array 102+distance L from bottom surface of the lens array to convergence point after beam converged by the lens array.

The substrate 109 of embodiment of the present invention provides only a fixed bonding plane. In practice, coupling structure of the waveguide chip 101 and the PD 102 may be used in a module box, in which the substrate 109 of the waveguide gasket 108 is bottom surface of the module box.

Implementing of the coupling device of an optical waveguide chip and a PD array lens of embodiment of the present invention as shown in FIG. 1 comprises the steps of:

Step 1: through operation of pasting, the heat sink 107 being bonded to the substrate 109, PD array 102 being bonded to the heat sink 107, wherein photosensitive surface of the PD array 102 faces up, adhesive glue among them is a conductive adhesive;

Step 2: elongated lens array 103 being bonded to the lens holder 106, height H1 of which is predesigned, and is equal to height H2 of the PD array 102+distance L from bottom surface of the lens array to convergence point after beam converged by the lens array;

Step 3: the lens array 103 being bonded to the lens holder 106, adjusting the lens array 103 bonded with the lens holder 106 lens to just above the PD array 102 under a microscope, during the pasting, seeing through the lens array 103 an enlarged image of the PD array 102, adjusting left-right position of the lens array 130 such that image on the photosensitive surface of the PD array 102 is positioned just in the center of clear aperture of lens, then carry out adhesive dispensing and solidification;

Step 4: removing a portion of the substrate with length of 2˜4 mm and thickness of 0.3˜0.5 mm, as shown in FIG. 4;

Step 5: After removal of the substrate, bonding the reflection prism 104 onto the outer sides of the cover glass 105 of the waveguide chip 101, during which it should ensure that the reflection prism 104 is parallel to top surface of the cover glass 105, such that the slope of the reflection prism 104 is corresponding to the output of the waveguide chip 101;

Step 6: bonding the waveguide gasket 108 to the bottom surface of the waveguide chip 101. Alignment of the waveguide array chip 101 and PD array 102 can now start. Alignment of coupling is carried out in active manner, with two Picoammeters monitoring photocurrent of beginning and end channels of PD array 102. The waveguide chip 101 is fixed by clamps to a six-dimensional fine-tuning shelve, in which by adjusting knob on the fine-tuning shelve, it is achieved the coupling alignment. During the adjusting, amplitude of generated photocurrent is monitored in real time. When readings of the two Picoammeters reach maximum at same time, it indicates that the waveguide chip 101 and the PD array 102 reach maximum coupling efficiency. Alignment of coupling is finished, then adhesive dispensing and solidification are carried out between the waveguide gasket 108 and the substrate 109, that is, alignment of coupling between the waveguide chip 101 and the PD array 102 is realized.

The waveguide chip 101 in steps 4-6 has 4 output channels with spacing of 250 μm therebetween. Correspondingly, the lens array consists of 4 lenses, also with spacing of 250 μm therebetween. The waveguide chip 101 is coupled with a reflection prism 104 on each 4 channels.

In step 3, during lens pasting, alternatively, image processing program can be used to assist determining whether center of the clear aperture of the lens array 103 being aligned with center of the photosensitive surface of the PD array center 102, in a manner as follows: replacing microscope with CCD (Charge-coupled Device) to capture image in pasting operation in real-time; the CCD is connected to data acquisition card in computer, in which position of the center of the clear aperture of the lens array is analyzed in a manner of image processing, and position of image of the photosensitive surface of the PD array is analyzed, then pixel difference between the two positions is calculated, for auxiliary judgment of the operator. In this way, by analyzing difference of the positions of the center of the clear aperture and the photosensitive surface in real time, the lens array 103 and the PD array center 102 can be aligned with high accuracy and good repeatability.

In step 5, reflective surface of the reflection prism is coated with reflection-increasing film. The reflection prism is mainly provided with a reflective surface, which is to deflect the optical path, without special requirements on materials thereof.

As shown in FIG. 4 as a side view of the waveguide chip, a portion of the substrate of the coupling end of the waveguide chip 101 is cut, for shortening the optical distance of the incident light, and ensuring the waveguide chip 101 to lower down to designed height, thus facilitating the coupling with the lens array 103. The end face of the output of the waveguide chip 101 is coated with antireflection film. According to Fresnel law of reflection, without coated with the antireflection film, 4.5% of the incident light will be reflected back on the end face of the chip. On the other hand, with coated with the antireflection film, at least 99.9% of the incident light will transmit through the coupling surface of the waveguide, and the return loss of the entire device will be controlled at −30 dB or less.

This efficient lens coupling scheme provided by embodiments of the invention uses combined optically passive and active alignment manner, makes the optical path between the waveguide chip 101 and PD array 102 provided with a reflection prism 104. Light output from the waveguide chip is reflected by the reflection prism 104, and received by the PD array 102. Further, a lens array 103 with convergent effect is set in optical path between the waveguide chip 101 and the PD array 102. The embodiments of the invention may implement high-precision alignment between the waveguide chip 101 and lens arrays 103, PD array 102. Passive alignment solution between lens arrays 103 and PD array 102 reduces alignment time, improves alignment efficiency and ensures alignment repeatability, reducing the operator's operational requirements to ensure product consistency.

In this solution, alignment between the lens array 103 and the PD array 102 is carried out by way of manual pasting, and can combine with image processing program to conduct image analysis on the central position, thus improving the alignment accuracy and repeatability. The solution realizes high alignment accuracy, simple operation and high production efficiency, is suitable for batch production; the entire solution uses a lens array 103, which can decrease member quantity of assembly, save cost, and reduce process difficulty, as compared with the solution of coupling structure designed by NTT using two lens arrays plus reflection prism.

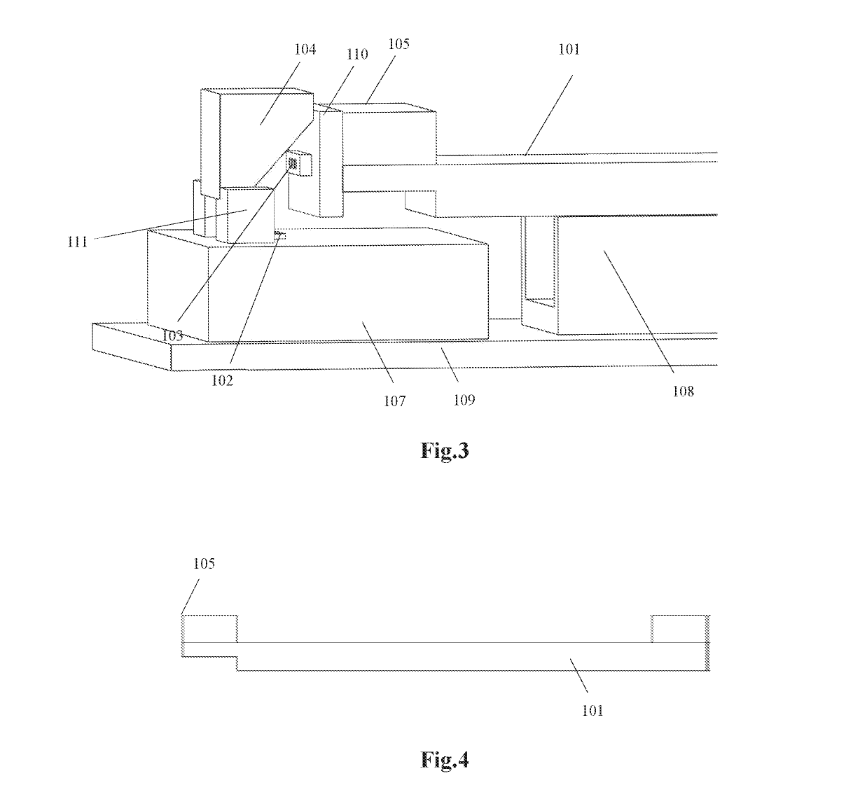

With the first coupling structure proposed by embodiment of the invention, prism after cutting corner is pasted on glass of surface of the waveguide. Light travels divergently in air after emitted from the waveguide, is then reflected by the prism, in which the optical path is deflected by 60˜120° (preferably 80˜100°), then arrives on the top surface of the lens with beam waist of about 60 μm. Finally, light is focused by lens to converge and irradiate to the photosensitive surface, thus achieving photoelectric conversion. Based on the idea that use a lens array and a reflection prism to achieve photocoupling, embodiment of the present invention provides a second structure for photocoupling. A coupling structure of the second embodiment is shown in FIG. 3, in which adhesive manner and positions of a substrate 109, a heat sink 107 and a PD array 102 are same with the first embodiment. The heat sink 107 is located above the substrate 109. The PD array 102 is bonded to the heat sink 107 through conductive glue. A transparent sheet 110 is bonded to the end face of output of the waveguide chip 101. Convexity of lens array 103 is bonded to the transparent plate 110 along direction of the optical path. Lens bonding requires one-to-one correspondence of the centers of the apertures of the waveguide chip 101 and the lens array 103. Alignment process is similar to pasting operation in above step 3: the waveguide chip 101 is vertically placed. Image of rectangular waveguide is seen under the microscope through a lens. The position of the lens array is adjusted. When it can be seen that the waveguide array is positioned on center of aperture of the lens array, point glue curing, adhesive dispensing and solidification are carried out. The reflection prism 104 is fixed on the reflection prism holder 111. Reflection angle of the reflection prism 104 is 30 to 60° (preferably 40 to 50°). The reflection prism holder 111 is bonded beside the PD array 102, which is corresponding to the slope of the reflection prism 104. Light emitted from the waveguide chip 101 travels through the lens array 103 and is converged on the slope of the reflection prism 104, after reflected thereon, deflected by 60 to 120° (preferably 80 to 100°), and converged to photosensitive surface of the PD array 102. Alignment of the waveguide chip 101 and the PD array 102 is carried out also in active manner. With reference to above step 6, the transparent sheet 110 may be selected as glass or silicon sheet, preferably quartz glass sheet, whose role is to prevent light output from waveguide chip 101 not diverged in transmission. In the second embodiment, lower substrate of the output of the waveguide chip 101 is provided with a cut-out region with length of 2˜4 mm and thickness of 0.3˜0.5 mm. Function of lower substrate of the output of the waveguide chip 101 being provided with a cut-out region is to shorten output optical distance after outputting of lens in lens array.

Mentioned above are only a few embodiment examples of the invention. Though specific and detailed in description, they should not thereby be understood as limitations to the application scope of this invention. What should be noted is that, possible variations and modifications developed by ordinary technicians in this field, without departing from the inventive concept of this invention, are all covered in the protection scope of this invention. Thus the protection scope of this invention should be subject to the appended Claims.

1. A coupling device of optical waveguide chip and PD array lens comprising a waveguide chip, a PD array, a heat sink, a waveguide gasket, and a substrate, wherein the waveguide gasket and the heat sink are located on the substrate, the PD array (102) is positioned on the heat sink, the waveguide chip is set on the waveguide gasket,
wherein a reflection prism is set in optical path between the waveguide chip and the PD array, light output from the waveguide chip is reflected by the reflection prism, and received by the PD array, and
a lens array with convergent effect is set in optical path between the waveguide chip and the PD array.

2. The coupling device of claim 1, wherein a lens holder is set on both sides of the PD array, the lens array is fixed on the lens holder, center of transmission surface of the lens array is aligned with center of photosensitive surface of the PD array, cover glass is bonded on top side of the waveguide chip, the reflection prism is pasted to outside of the cover glass, slope of reflection prism is corresponding to output side of the waveguide chip.

3. The coupling device of claim 1, wherein reflection angle of the reflection prism is 40 to 50°, reflection plane is coated with reflection-increasing film.

4. The coupling device of claim 3, wherein underlying substrate of output of the waveguide chip is provided with cut-out region, with length of 2˜4 mm and thickness of 0.3˜0.5 mm.

5. The coupling device of claim 3, wherein Height H1 of the lens holder equals to sum of height H2 of PD array and distance L from bottom surface of the lens array to convergence point after beam passing the lens array to be converged.

6. The coupling device of claim 1, wherein cover glass is bonded on top side of the waveguide chip, transparent sheet is pasted to end surface of the output of the waveguide chip, the lens array is bonded on the transparent sheet, centers of apertures of the waveguide chip and the lens array are corresponded each other, the reflection prism is fixed on reflection prism holder, which is bonded beside PD array, which corresponds to slope of the reflection prism.

7. The coupling device of claim 1, wherein the waveguide chip is provided with four output channels with spacing of 250 μm therebetween, the lens array includes four lenses with spacing of 250 μm therebetween.

8. The coupling device of claim 6, wherein underlying substrate of output of the waveguide chip is provided with cut-out region, with length of 2˜4 mm and thickness of 0.3˜0.5 mm.

9. The coupling device of claim 2, wherein end surface of the output of the waveguide chip is coated with antireflection film.

10. The coupling device of claim 6, wherein the transparent sheet is a glass or silicon sheet.

11. The coupling device of claim 2, wherein reflection angle of the reflection prism is 40 to 50°, reflection plane is coated with reflection-increasing film.

12. The coupling device of claim 11, wherein underlying substrate of output of the waveguide chip is provided with cut-out region, with length of 2˜4 mm and thickness of 0.3˜0.5 mm.

13. The coupling device of claim 11, wherein Height H1 of the lens holder equals to sum of height H2 of PD array and distance L from bottom surface of the lens array to convergence point after beam passing the lens array to be converged.

14. The coupling device of claim 6, wherein the waveguide chip is provided with four output channels with spacing of 250 μm therebetween, the lens array includes four lenses with spacing of 250 μm therebetween.
